(19) United States
(12) Patent Application Publication
(10) Pub. No.: US 2018/0345467 A1
(43) Pub. Date: Dec. 6, 2018

(54) TOOL FOR ATTACHING AND REMOVING LOOSE WHEEL NUT INDICATORS

(71) Applicant: Dean Steven Ploumitsakos, Whiting, NJ (US)

(72) Inventor: Dean Steven Ploumitsakos, Whiting, NJ (US)

(21) Appl. No.: 15/609,728

(22) Filed: May 31, 2017

(51) Int. Cl. B25B 27/14; F16B 31/02

(52) U.S. Cl. CPC B25B 27/14; B60B 27/065; B60B 2320/10; F16B 31/02

(57) ABSTRACT

A tool for installing and removing wheel nut indicators. The tool includes an elongated handle having a first end opposite a second end. An indicator holder is coupled to the second end. The indicator holder includes an end plate and a sidewall. The end plate is substantially perpendicular to the elongated handle and the sidewall extends from the end plate and is substantially perpendicular to the end plate. An inner surface and a cross section of the sidewall forms a teardrop shape. A wheel nut indicator form fits within the indicator holder.

### BACKGROUND OF THE INVENTION

The present invention relates to wheel nut indicators and, more particularly, to a tool for attaching and removing loose wheel nut indicators.

Loose wheel nut indicators are small pointed tags, usually made of fluorescent orange or yellow plastic, which are fixed to the lug nuts of the wheels of large vehicles. The tag rotates with the nut, and if the nut becomes loose, the point of the tag shifts noticeably out of alignment with the other tags. If too many lug nuts are loosened, the wheel can detach from the wheel stud; loose wheel nut indicators allow identification of loose nuts before this can occur. Currently, loose wheel nut indicators are attached and removed from a wheel nut by hand. Attaching and removing the loose wheel nut indicators by hand can cause injury.

As can be seen, there is a need for a tool for attaching and removing loose wheel nut indicators

### SUMMARY OF THE INVENTION

In one aspect of the present invention, a tool comprises: an elongated handle comprising a first end opposite a second end; and an indicator holder comprising an end plate coupled to the second end, wherein the end plate is substantially perpendicular to the elongated handle, and a sidewall extending from the end plate and substantially perpendicular to the end plate, wherein an inner surface of the sidewall forms a teardrop shape.

In another aspect of the present invention, a method of engaging loose nut indicators with wheel nuts comprises: providing a tool comprising: an elongated handle comprising a first end opposite a second end; an end plate coupled to the second end of the elongated handle; and a sidewall extending from the end plate, wherein an inner surface of the sidewall forms a teardrop shape; placing a loose nut indicator within the sidewall of the tool; placing the sidewall of the tool over a wheel nut of a wheel; and pushing the loose nut indicator over the wheel nut using the tool.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is an enlarged cross sectional view of an embodiment of the present invention shown in use during installation;

FIG. 3 is an enlarged cross sectional view of an embodiment of the present invention shown in use during removal;

FIG. 4 is an enlarged cross sectional view of an embodiment of the present invention shown in use during removal;

FIG. 5 is a top view of an embodiment of the present invention; and

FIG. 6 is a bottom view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

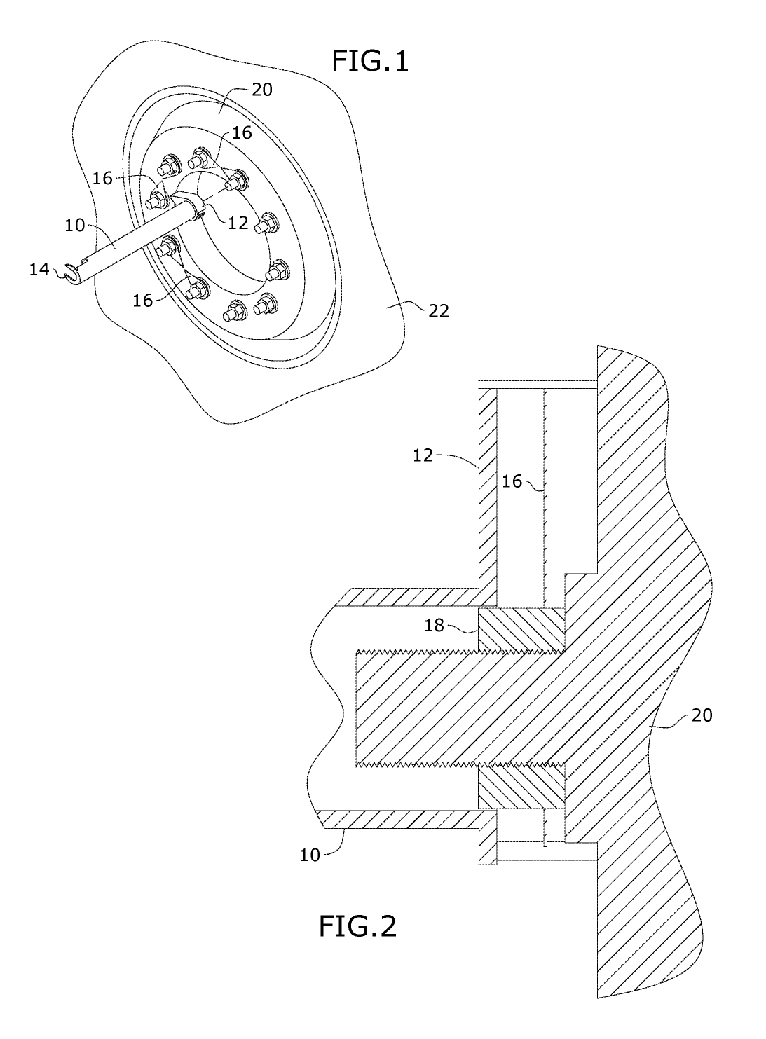

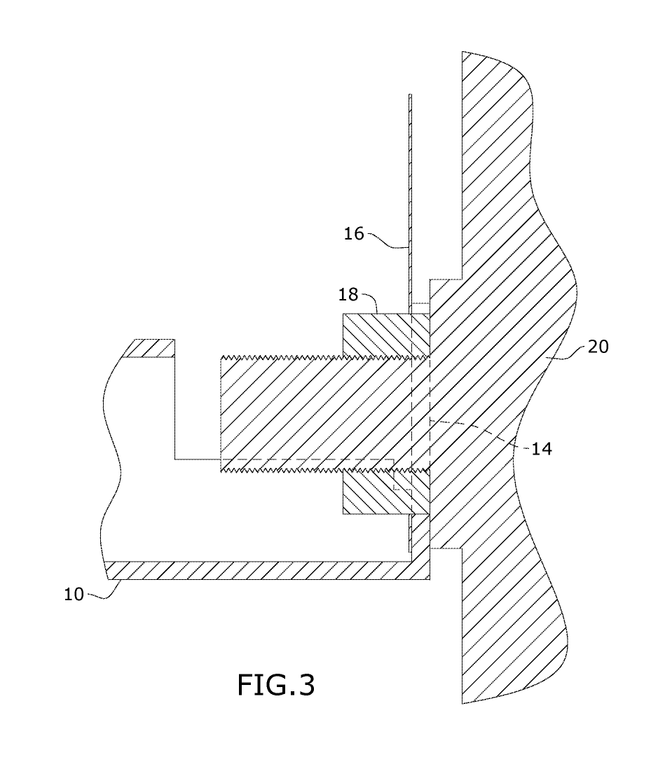

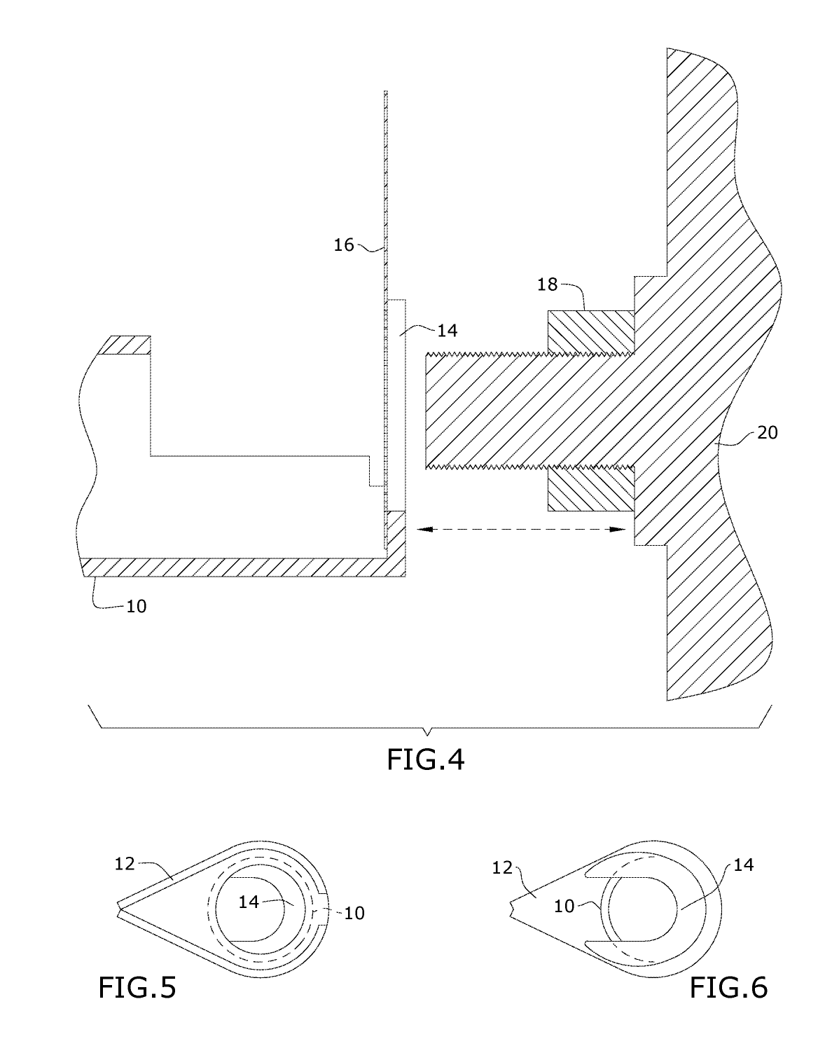

Referring to FIGS. 1 through 6, the present invention includes a tool. The tool includes an elongated handle 10 having a first end opposite a second end. An indicator holder 12 is coupled to the second end. The indicator holder 12 includes an end plate and a sidewall. The end plate is substantially perpendicular to the elongated handle 10 and the sidewall extends from the end plate and is substantially perpendicular to the end plate. An inner surface and a cross section of the sidewall forms a teardrop shape. Therefore, a wheel nut indicator 16 form fits within the indicator holder 12.

The handle 10 of the tool may be substantially straight and rigid. The handle 10 may be a tube having a hollow core running from the first end to the second end. The tube may have a cylindrical shape. Alternatively, the tube may be square shaped, triangular and the like.

In certain embodiments, the end plate of the indicator holder 12 has an opening. The opening of the end plate intersects with the hollow core of the handle 10. Therefore, when installing the wheel indicator, the bolt and wheel nut 18 may protrude into the hollow core of the handle 10. In certain embodiments, the indicator holder 12 as a whole may form a teardrop shape. In such embodiments, an outer edge of the end plate forms the teardrop shape.

The tool of the present invention may further include an indicator remover 14. The indicator remover 14 may include a U-shaped plate having a pair of arms having distal ends and proximal ends. The proximal ends of the pair of arms are connected together by a base, forming the U-shape. The U-shaped plate is coupled to the first end. The U-shaped plate may be substantially perpendicular to the elongated handle 10. The inner edge of the U-shaped plate may intersect with the hollow core of the elongated handle 10. In certain embodiments, the elongated handle may include a cutout portion adjacent to the ends of the pair of arms of the U-shaped plate, providing clearance for the bolt and wheel nut 18 while using the tool.

A method of using the present invention may include the following steps: providing the tool mentioned above; placing a loose nut indicator 16 within the indicator holder 12 of the tool; placing the indicator holder 12 of the tool over a wheel nut 18 of a wheel 20, the wheel 20 having a tire 22 attached; and pushing the loose nut indicator 16 over the wheel nut 18 using the tool. A method of removing the loose nut indicator 16 may include the following steps: placing the U-shaped plate in between the loose nut indicator 16 and the wheel 20; pulling the handle 10 and thereby pulling the loose nut indicator 16 off of the wheel nut 18.

It should be understood, of course, that the foregoing relates to exemplary embodiments of the invention and that modifications may be made without departing from the spirit and scope of the invention as set forth in the following claims.

What is claimed is:

1. A tool comprising:
an elongated handle comprising a first end opposite a second end; and
an indicator holder comprising an end plate coupled to the second end, wherein the end plate is substantially perpendicular to the elongated handle, and a sidewall extending from the end plate and substantially perpendicular to the end plate, wherein an inner surface of the sidewall forms a teardrop shape.

2. The tool of claim 1, wherein the elongated handle comprises a tube comprising a hollow core, wherein the end plate comprises an opening intersecting with the hollow core.

3. The tool of claim 1, wherein an outer edge of the end plate forms the teardrop shape.

4. The tool of claim 1, further comprising an indicator remover comprising a U-shaped plate coupled to the first end, wherein the U-shaped plate is substantially perpendicular to the elongated handle.

5. The tool of claim 1, wherein the elongated handle comprises a tube comprising a hollow core, wherein an inner edge of the U-shaped plate intersects with the hollow core.

6. The tool of claim 5, wherein the tube comprises a cut out portion adjacent to distal ends of a pair of arms of the U-shaped plate.

7. A method of engaging loose nut indicators with wheel nuts comprising:
providing a tool comprising:
an elongated handle comprising a first end opposite a second end;
an end plate coupled to the second end of the elongated handle; and
a sidewall extending from the end plate, wherein an inner surface of the sidewall forms a teardrop shape;
placing a loose nut indicator within the sidewall of the tool;
placing the sidewall of the tool over a wheel nut of a wheel; and
pushing the loose nut indicator over the wheel nut using the tool.

8. The method of claim 7, wherein the elongated handle comprises a tube comprising a hollow core, wherein the end plate comprises an opening intersecting with the hollow core.

9. The method of claim 7, wherein the tool further comprises a U-shaped plate coupled to the first end.

10. The method of claim 9, further comprising the steps of:
placing the U-shaped plate in between the loose nut indicator and the wheel;
pulling the handle and thereby pulling the loose nut indicator off of the wheel nut.
